(19) United States
(12) Patent Application Publication
(10) Pub. No.: US 2025/0373148 A1
(43) Pub. Date: Dec. 4, 2025

(54) VOLTAGE CONVERTING CIRCUIT AND METHOD FOR CONVERTING VOLTAGE

(71) Applicant: PowerX Semiconductor Corporation, Hsinchu County (TW)

(72) Inventors: Chun-Hung CHANG, Hsinchu County (TW); Chung-Sheng CHENG, Hsinchu County (TW)

(21) Appl. No.: 18/928,221

(22) Filed: Oct. 28, 2024

(30) Foreign Application Priority Data
May 31, 2024 (TW) 113120382

(51) Int. Cl. H02M 1/32; H02M 1/088; H02M 3/158

(52) U.S. Cl. CPC H02M 1/32; H02M 1/088; H02M 3/158

(57) ABSTRACT

A voltage converting circuit includes a logic circuit, a driver control circuit, a high-side switch, a low-side switch, and a discharge switch. The logic circuit receives a PWM signal from an input node and outputs first and second control signals according to the PWM signal. The driver control circuit receives the first and second control signals and outputs a high-side control signal and a low-side control signal according to the first and second control signals. The high-side and low-side switches respectively receive the high-side control signal and the low-side control signal and correspondingly output a phase output signal. The discharge switch is coupled between the input node and a ground terminal and controlled by at least one of the PWM signal, the first control signal, an inversion of the second control signal, the high-side control signal, an inversion of the low-side control signal, and the phase output signal.

### CROSS-REFERENCE TO RELATED APPLICATION

This application claims priority to Taiwan Application Serial Number 113120382, filed May 31, 2024, which is herein incorporated by reference in its entirety.

### BACKGROUND

### Field of Invention

The present disclosure relates to a voltage converting circuit.

### Description of Related Art

A known voltage converting circuit receives a pulse-width modulation (PWM) signal and provides a first gate driving signal and a second gate driving signal respectively to a high-side switch and a low-side switch based on the PWM signal. The high-side switch is alternately turned on and off according to the first gate driving signal, and the low-side switch is alternately turned on and off according to the second gate driving signal, such that the high-side switch and/or the low-side switch output a voltage signal accordingly. However, during the period when the PWM signal is transitioning from a high logic mode to a high-impedance logic mode, the rate at which the voltage of the PWM signal drops may be too small, such that a conduction time of the high-side switch becomes longer. Accordingly, the voltage signal outputted by the high-side switch is too large, which may induce a risk of damaging the high-side switch.

### SUMMARY

The present disclosure provides a voltage converting circuit including a logic circuit, a driver control circuit, a high-side switch, a low-side switch, and a discharge switch. The logic circuit is coupled to an input node to receive a PWM signal and outputs a first control signal and a second control signal according to the PWM signal. The driver control circuit is coupled to the logic circuit to receive the first and second control signals and outputs a high-side control signal and a low-side control signal according to the first and second control signals. The driver control circuit further receives a bootstrap power signal for driving the driver control circuit. A control terminal of the high-side switch is coupled to the driver control circuit to receive the high-side control signal. A control terminal of the low-side switch is coupled to the driver control circuit to receive the low-side control signal. A first terminal of the low-side switch and a second terminal of the high-side switch are coupled to a switching node, and a phase output signal is generated at the switching node. The discharge switch is coupled between the input node and a ground terminal. The discharge switch is controlled by at least one of the PWM signal, the first control signal, an inversion of the second control signal, the bootstrap power signal, the high-side control signal, an inversion of the low-side control signal, and the phase output signal.

The present disclosure further provides a method for converting voltage. The method for converting voltage includes: providing a PWM signal by an input node; by a logic circuit, receiving the PWM signal and outputting a first control signal and a second control signal according to the PWM signal; by a driver control circuit, receiving the first and second control signals and outputting a high-side control signal and a low-side control signal according to the first and second control signals, in which a bootstrap power signal for driving the driver control circuit is further received by the driver control circuit; receiving the high-side control signal by a control terminal of a high-side switch; receiving the low-side control signal by a control terminal of a low-side switch; outputting a phase output signal at a first terminal of the low-side switch and a second terminal of the high-side switch; and controlling an on/off state of a discharge switch. The discharge switch is coupled between the input node and a ground terminal. The discharge switch is controlled by at least one of the PWM signal, the first control signal, an inversion of the second control signal, the bootstrap power signal, the high-side control signal, an inversion of the low-side control signal, and the phase output signal.

In order to let above mention of the present invention and other objects, features, advantages, and embodiments of the present invention to be more easily understood, the description of the accompanying drawing as follows.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a circuit diagram of a voltage converting circuit according to an illustrative example of the present disclosure.

FIG. 2 is a timing chart of various signals of the voltage converting circuit of FIG. 1.

FIG. 3 is a circuit diagram of a voltage converting circuit according to one embodiment of the present disclosure.

FIG. 4 is a circuit diagram of the logic circuit according to another embodiment of the present disclosure.

FIG. 5 is a timing chart of various signals of a voltage converting circuit according to one embodiment of the present disclosure.

FIG. 6 is a circuit diagram of a voltage converting circuit according to another embodiment of the present disclosure.

FIG. 7 is a circuit diagram of a voltage converting circuit according to another embodiment of the present disclosure.

FIG. 8 is a circuit diagram of a voltage converting circuit according to another embodiment of the present disclosure.

FIG. 9 is a circuit diagram of a voltage converting circuit according to another embodiment of the present disclosure.

FIG. 10 is a circuit diagram of a voltage converting circuit according to another embodiment of the present disclosure.

FIG. 11 is a circuit diagram of a voltage converting circuit according to another embodiment of the present disclosure.

FIG. 12 is a circuit diagram of a voltage converting circuit according to another embodiment of the present disclosure.

FIG. 13 is a circuit diagram of a voltage converting circuit according to another embodiment of the present disclosure.

FIG. 14 is a circuit diagram of a voltage converting circuit according to another embodiment of the present disclosure.

FIG. 15 is a timing chart of various signals of the voltage converting circuit according to another embodiment of the present disclosure.

FIG. 16 is a circuit diagram of a voltage converting circuit according to another embodiment of the present disclosure.

FIG. 17 is a circuit diagram of a voltage converting circuit according to another embodiment of the present disclosure.

FIG. 18 is a circuit diagram of a voltage converting circuit according to another embodiment of the present disclosure.

FIG. 19 is a circuit diagram of a switch control circuit according to an embodiment of the present disclosure.

FIG. 20 is a timing chart of various signals of a voltage converting circuit according to another embodiment of the present disclosure.

FIG. 21 is a flow chart of a voltage converting method according to another embodiment of the present disclosure.

### DETAILED DESCRIPTION

Specific embodiments of the present invention are further described in detail below, however, the embodiments described are not intended to limit the present invention and it is not intended for the description of operation to limit the order of implementation. The using of “first”, “second”, “third”, etc. in the specification should be understood for identify units or data described by the same terminology, but is not referred to particular order or sequence.

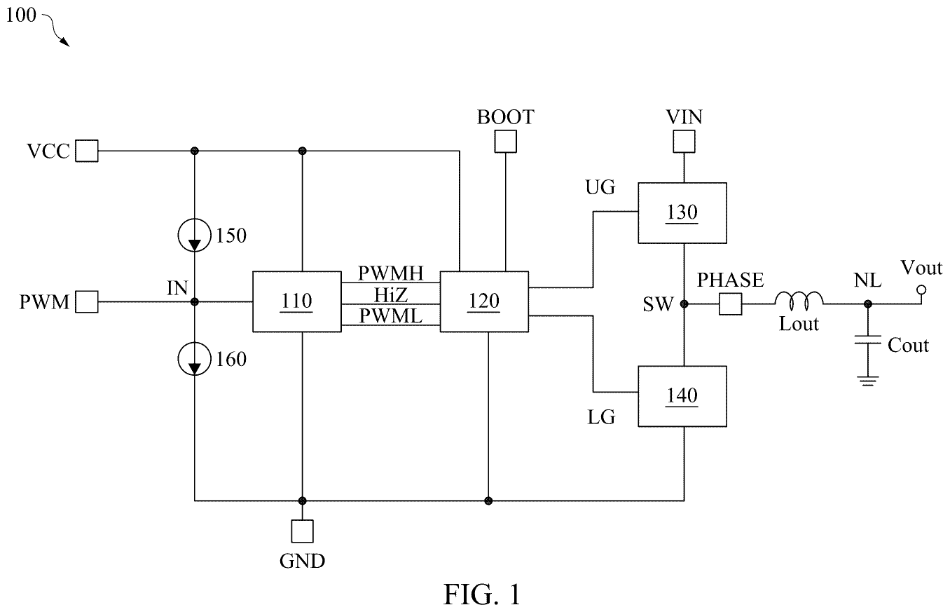

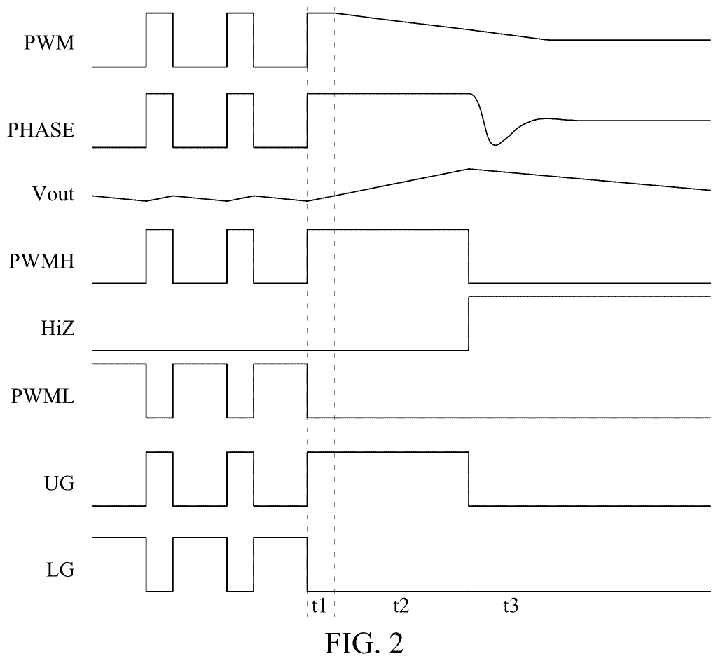

FIG. 1 is a circuit diagram of a voltage converting circuit 100 according to an illustrative example of the present disclosure. The voltage converting circuit 100 includes a logic circuit 110, a driver control circuit 120, a high-side switch 130, a low-side switch 140, a current source 150, a current sink 160, an output inductor Lout, and an output capacitor Cout. FIG. 2 is a timing chart of various signals of the voltage converting circuit 100.

The logic circuit 110 is coupled to an input node IN to receive a pulse width modulation (PWM) signal PWM. The logic circuit 110 outputs a first control signal PWMH, a second control signal PWML, and a third control signal HiZ according to the PWM signal PWM. It is worth mentioning that the PWM signal PWM is provided from or driven by a front stage circuit (not shown in FIG. 1). When the PWM signal PWM is driven by the front stage circuit to be in a high logic mode, the first control signal PWMH is at a high level, while the second control signal PWML and the third control signal HiZ are at a low level. When the PWM signal PWM is driven by the front stage circuit to be in a low logic mode, the second control signal PWML is at a high level, while the first control signal PWMH and the third control signal HiZ are at the low level. When the PWM signal PWM is not driven by the front stage circuit to be in a high-impedance logic mode (also referred to as a tri-state mode), the third control signal HiZ is at a high level, while the first control signal PWMH and the second control signal PWML are at a low level.

The driver control circuit 120 is coupled to the logic circuit 110 to receive the first control signal PWMH, the second control signal PWML and the third control signal HiZ, thereby outputting a high-side control signal UG and a low-side control signal LG. The driver control circuit 120 further receives a bootstrap power signal BOOT for driving the driver control circuit 120. The high-side control signal UG has a positive correlation with the first control signal PWMH and further has a negative correlation with the low-side control signal LG. The present disclosure does not intend to limit the components constituting the driver control circuit 120, and any circuit, which can receive the first control signal PWMH, the second control signal PWML, and the third control signal HiZ and correspondingly output the high-side control signal UG and the low-side control signal LG, is applicable to the present disclosure.

A control terminal of the high-side switch 130 is coupled to the driver control circuit 120 to receive the high-side control signal UG. A control terminal of the low-side switch 140 is coupled to the driver control circuit 120 to receive the low-side control signal LG. A first terminal of the high-side switch 130 is coupled to a voltage source VIN. A second terminal of the low-side switch 140 is coupled to a ground terminal GND. A first terminal of the low-side switch 140 and a second terminal of the high-side switch 130 are coupled to a switching node SW. The high-side switch 130 and the low-side switch 140 output a phase output signal PHASE at the switching node SW. In other words, the phase output signal PHASE is generated at the switching node SW. In some embodiments of the present disclosure, the high-side switch 130 and the low-side switch 140 are, for example, N-type metal oxide semiconductor field effect transistors (MOSFETs), but the present disclosure is not limited thereto. When the high-side switch 130 is implemented by an N-type MOSFET, a gate terminal, a drain terminal and a source terminal of the N-type MOSFET respectively correspond to the control terminal, the first terminal, and the second terminal of the high-side switch 130. When the low-side switch 140 is implemented by an N-type MOSFET, the gate terminal, the drain terminal, and the source terminal of the N-type MOSFET respectively correspond to the control terminal, the first terminal, and the second terminal of the low-side switch 140.

The output inductor Lout is coupled between the switching node SW and a load node NL. The output inductor Lout and the output capacitor Cout form a filter to perform a filter operation on the phase output signal PHASE, thereby generating an output voltage Vout at the load node NL.

When the PWM signal PWM is not driven by the front stage circuit (not shown in FIG. 1), the current source 150 pulls up a voltage value of the PWM signal PWM through a voltage source VCC, and the current sink 160 pulls down the voltage value of the PWM signal PWM through the ground terminal GND. Specifically, the current source 150 and the current sink 160 cooperate with each other to control the PWM signal PWM to have a desired voltage level, such as a high-impedance logic level.

As shown in FIG. 2, during a time period t1, the PWM signal PWM is in a high logic mode (also referred to as a Hi mode). As shown in FIG. 2, during a time period t3, the PWM signal PWM is in a tri-state mode (also referred to as a high-impedance logic mode). During a time period t2, the PWM signal PWM is in a process of transitioning from the high logic mode to the high-impedance logic mode. Specifically, during the time period t2, the voltage value of the PWM signal PWM is pulled down with a fixed sink current through the current sink 160. However, the above-mentioned sink current of the current sink 160 is not large enough, and thus the voltage value of the PWM signal PWM in FIG. 2 drops too slowly during the time period t2. Thus, the high-side switch 130 continues to be turned on because the high-side control signal UG is at a high level, which causes the output voltage Vout to continue to rise. However, when the output voltage Vout and the current of the output inductor Lout are too large, the high-side switch 130 may be damaged.

Therefore, the purpose of the present disclosure is to form or provide a fast discharge path for the PWM signal PWM when the PWM signal PWM is in the process of transitioning from the high logic mode to the high-impedance logic mode. Accordingly, the output voltage Vout and the current of the output inductor Lout are not too large, thereby avoiding damage to the high-side switch 130.

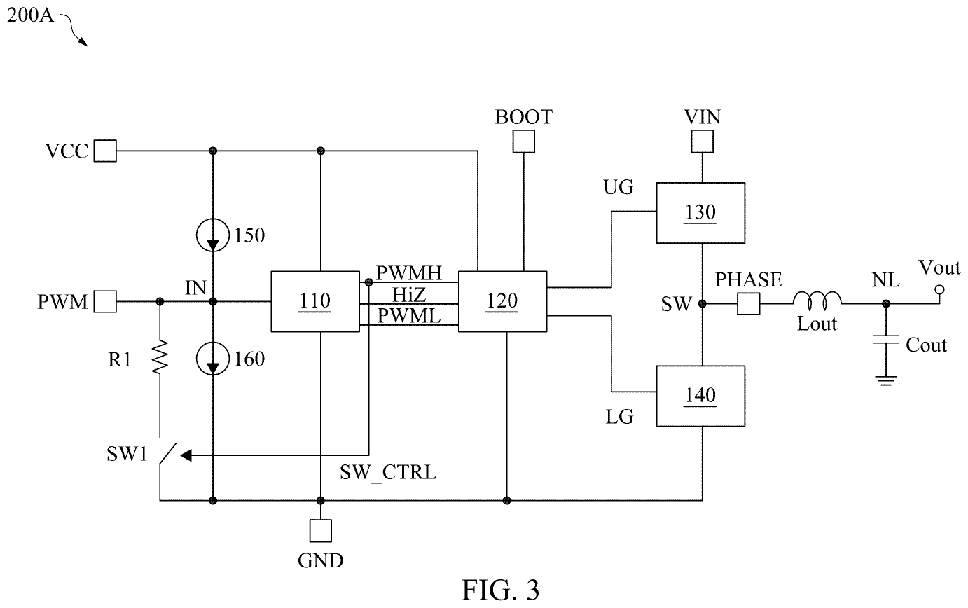

FIG. 3 is a circuit diagram of a voltage converting circuit 200A according to one embodiment of the present disclosure. The voltage converting circuit 200A is similar to the voltage converting circuit 100. The distinction between the voltage converting circuits 200A and 100 is that the voltage converting circuit 200A further includes a resistor R1 and a discharge switch SW1. The discharge switch SW1 is coupled between the input node IN and the ground terminal GND. Specifically, the resistor R1 and the discharge switch SW1 are connected in series between the input node IN and the ground terminal GND. The discharge switch SW1 is controlled by a switch control signal SW_CTRL. In some embodiments with respect to FIG. 3, the first control signal PWMH is provided as the switch control signal SW_CTRL to control the discharge switch SW1 (i.e., the switch control signal SW_CTRL of the discharge switch SW1 is the first control signal PWMH). When the first control signal PWMH is at the high level, the discharge switch SW1 is turned on to form a discharge path between the input node IN and the ground terminal GND, and the above-mentioned discharge path serves as a fast discharge path for the PWM signal PWM. Specifically, as shown in FIG. 3, the first control signal PWMH is provided to directly control the on/off state of the discharge switch SW1, that is, the discharge switch SW1 is directly controlled by the first control signal PWMH. In some embodiments of the present disclosure, the discharge switch SW1 is, for example, a transistor or a MOSFET, but the present disclosure is not limited thereto.

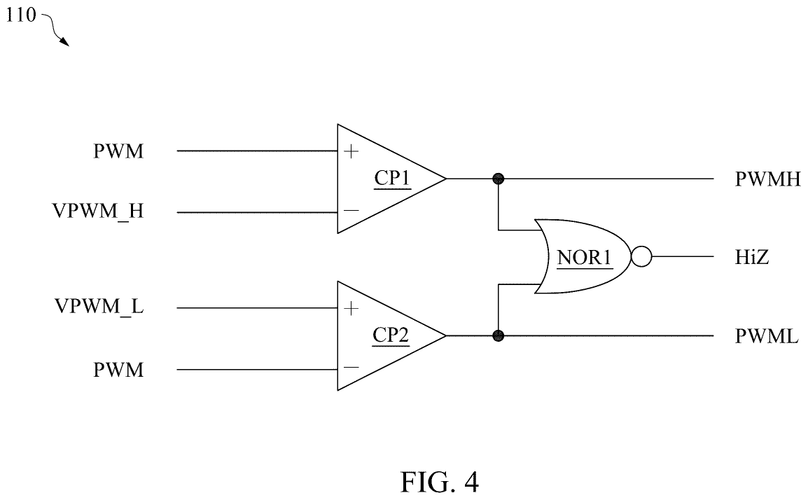

FIG. 4 is a circuit diagram of the logic circuit 110 according to another embodiment of the present disclosure. The logic circuit 110 includes a first comparator CP1, a second comparator CP2, and a NOR gate NOR1. A positive input terminal (labelled as “+” in FIG. 4) of the first comparator CP1 and a negative input terminal (labelled as “−” in FIG. 4) of the second comparator CP2 receive the PWM signal PWM. A negative input terminal of the first comparator CP1 receives a first high input threshold voltage VPWM_H, and a positive input terminal of the second comparator CP2 receives a first low input threshold voltage VPWM_L. The first comparator CP1 compares the PWM signal PWM with the first high input threshold voltage VPWM_H and outputs the first control signal PWMH according to the comparison result between the PWM signal PWM and the first high input threshold voltage VPWM_H. The second comparator CP2 compares the PWM signal PWM with the first low input threshold voltage VPWM_L and outputs the second control signal PWML according to the comparison result between the PWM signal PWM and the first low input threshold voltage VPWM_L. Two input terminals of the NOR gate NOR1 are coupled to an output terminal of the first comparator CP1 and an output terminal of the second comparator CP2 to receive the first control signal PWMH and the second control signal PWML, respectively, and outputs the third control signal HiZ according to the first control signal PWMH and the second control signal PWML.

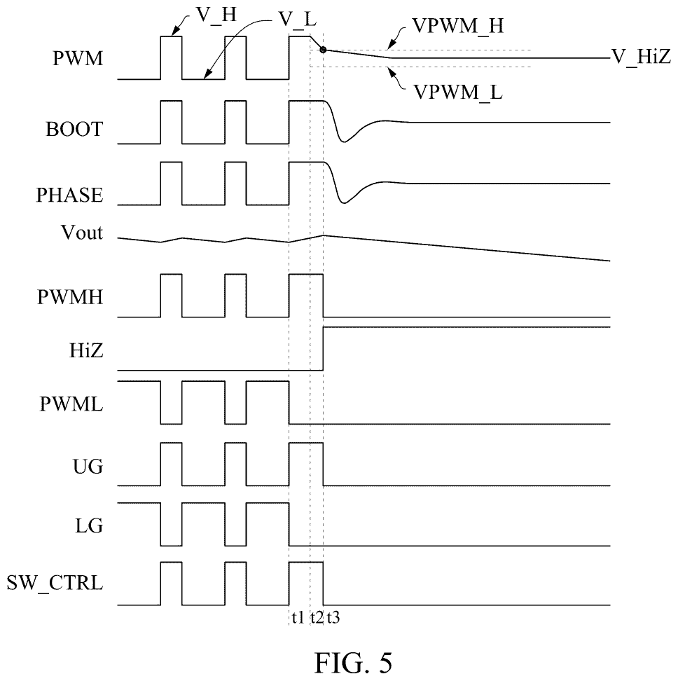

FIG. 5 is a timing chart of various signals of the voltage converting circuit 200A (also applicable to other voltage converting circuits 200B, 200C, 300, 400, 500, 600, 700 and 800 which will be described later). As shown in FIG. 5, a high-impedance logic level V_HiZ is between the first high input threshold voltage VPWM_H and the first low input threshold voltage VPWM_L. The first high input threshold voltage VPWM_H is lower than the high logic level V_H of the PWM signal PWM and further higher than the high-impedance logic level V_HiZ of the PWM signal PWM. The first low input threshold voltage VPWM_L is lower than the high-impedance logic level V_HiZ of the PWM signal PWM and further higher than the low logic level V_L thereof.

Specifically, as shown in FIG. 4, when the voltage value of the PWM signal PWM is higher than the first high input threshold voltage VPWM_H, the first control signal PWMH is at the high level, and the second control signal PWML and the third control signal HiZ are at the low level (i.e., the logic circuit 110 determines that the PWM signal PWM is in the high logic mode). When the voltage value of the PWM signal PWM is lower than the first low input threshold voltage VPWM_L, the second control signal PWML is at the high level, and the first control signal PWMH and the third control signal HiZ are at the low level (i.e., the logic circuit 110 determines that the PWM signal PWM is in the low logic mode). When the voltage value of the PWM signal PWM is lower than the first high input threshold voltage VPWM_H and further higher than the first low input threshold voltage VPWM_L, the third control signal HiZ is at the high level, and the first control signal PWMH and the second control signal PWML are at the low level (i.e., the logic circuit 110 determines that the PWM signal PWM is in the high-impedance logic mode). Therefore, the level of the third control signal HiZ can indicate whether the PWM signal PWM is in the high-impedance logic mode.

As shown in FIG. 5, during a time period t1, the PWM signal PWM is driven by the front stage circuit to be in the high logic mode. As shown in FIG. 5, during a time period t3, the PWM signal PWM is not driven by the front stage circuit to be in a high-impedance logic mode. During a time period t2, the PWM signal PWM is not driven by the front stage circuit and is in a process of transitioning from the high logic mode to the high-impedance logic mode. As shown in FIG. 3 and FIG. 5, during the time period t2, since the first control signal PWMH is at the high level, the discharge switch SW1 is turned on to form a fast discharge path for the PWM signal PWM. Specifically, when the voltage value of the PWM signal PWM is higher than the first high input threshold voltage VPWM_H, the first control signal PWMH is at the high level, so that the discharge switch SW1 is turned on to form the fast discharge path for the PWM signal PWM.

In other words, during the time period t2, the voltage value of the PWM signal PWM is pulled down by not only the sink current of the current sink 160 but also the fast discharge path formed by the discharge switch SW1. Compared FIG. 5 with FIG. 2, the rate at which the voltage value of the PWM signal PWM of the voltage converting circuit 200A drops is increased during the time period t2, thereby shortening a duration of the time period t2 (i.e., the conducting time of the high-side switch 130 is shortened). Therefore, the output voltage Vout and the current of the output inductor Lout are not too large, thereby avoiding damage to the high-side switch 130. Specifically, as shown in the time period t2 of FIG. 5, when the PWM signal PWM is not driven by the front stage circuit and is in the process of transitioning from the high logic mode to the high-impedance logic mode (i.e., the time period t2), the discharge switch SW1 is turned on (i.e., the switch control signal SW_CTRL is at a high level) to form a fast discharge path for the PWM signal PWM, thereby increasing the rate at which the voltage value of the PWM signal PWM drops. Specifically, as shown in the time period t3 of FIG. 5, when the PWM signal PWM is in the high-impedance logic mode (i.e., the time period t3), the discharge switch SW1 is turned off (i.e., the switch control signal SW_CTRL is at a low level).

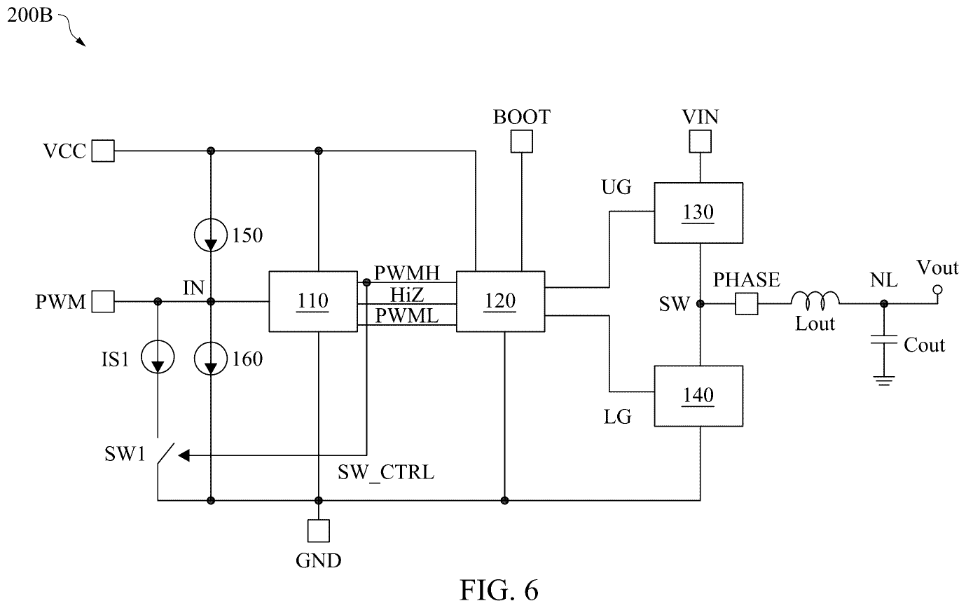

FIG. 6 is a circuit diagram of a voltage converting circuit 200B according to another embodiment of the present disclosure. The voltage converting circuit 200B is similar to the voltage converting circuit 200A. The distinction between the voltage converting circuits 200A and 200B is that the discharge switch SW1 of the voltage converting circuit 200B is connected in series with the current sink IS1 and coupled between the input node IN and the ground terminal GND.

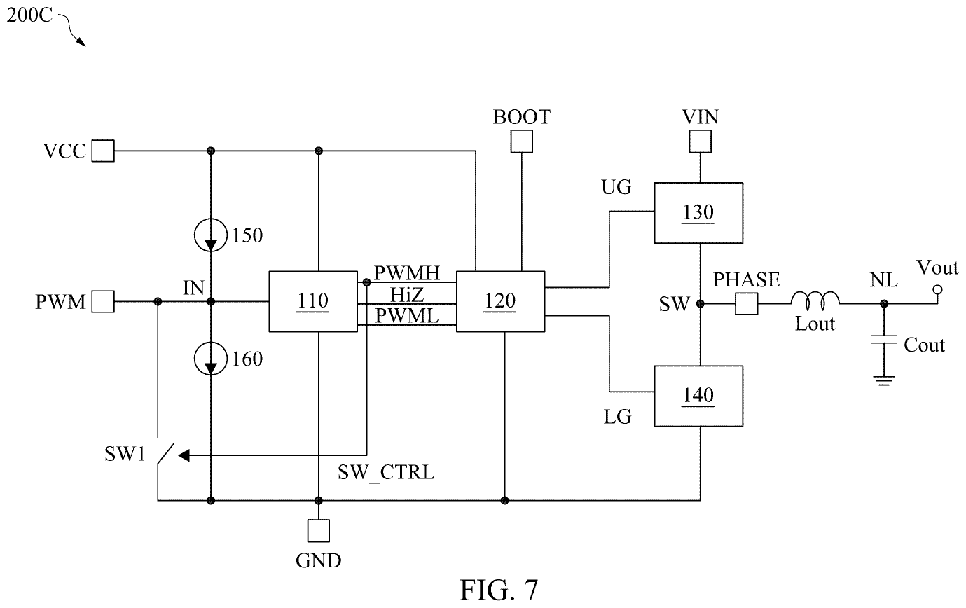

FIG. 7 is a circuit diagram of a voltage converting circuit 200C according to another embodiment of the present disclosure. The voltage converting circuit 200C is similar to the voltage converting circuits 200A and/or 200B. The distinction between the voltage converting circuit 200C and the voltage converting circuits 200A and/or 200B is that the discharge switch SW1 of the voltage converting circuit 200C is directly connected between the input node IN and the ground terminal GND. Specifically, the discharge switch SW1 of the voltage converting circuit 200C as shown in FIG. 7 is a switch with built-in impedance. Therefore, during the time period t2, when the discharge switch SW1 of the voltage converting circuit 200C is turned on, a fast discharge path can be formed for the PWM signal PWM through the built-in impedance of the discharge switch SW1, thereby pulling down the voltage value of the PWM signal PWM.

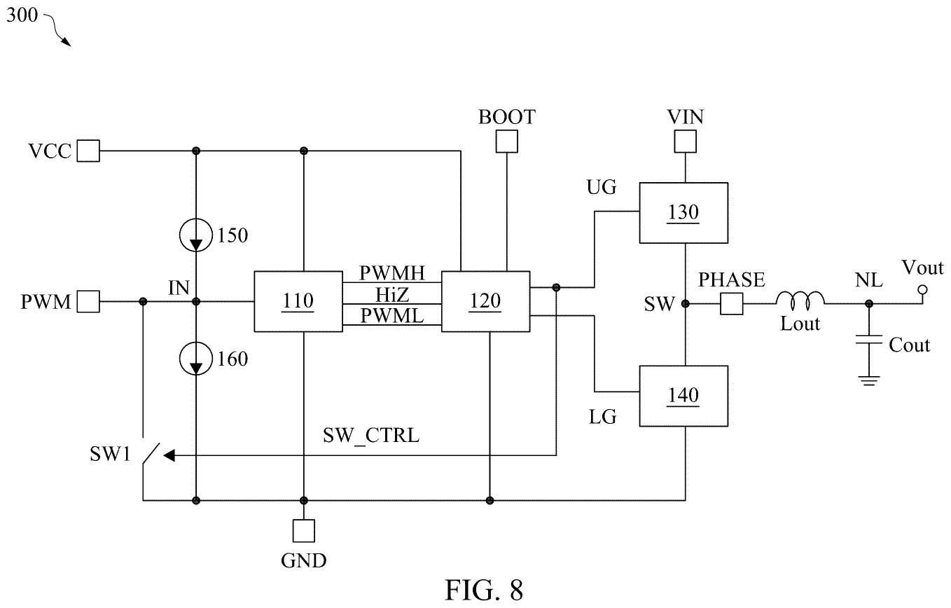

FIG. 8 is a circuit diagram of a voltage converting circuit 300 according to another embodiment of the present disclosure. The voltage converting circuit 300 is similar to the voltage converting circuit 200C. The distinction between the voltage converting circuits 300 and 200C is that the high-side control signal UG in the voltage converting circuit 300 is used as the switch control signal SW_CTRL to control the discharge switch SW1 (i.e., the switch control signal SW_CTRL of the discharge switch SW1 is the high-side control signal UG). When the high-side control signal UG is at the high level, the discharge switch SW1 is turned on to form a discharge path between the input node IN and the ground terminal GND, and the above-mentioned discharge path serves as a fast discharge path for the PWM signal PWM. Specifically, as shown in FIG. 8, the high-side control signal UG is used to directly control the on/off state of the discharge switch SW1, that is, the discharge switch SW1 is directly controlled by the high-side control signal UG. Specifically, as shown in FIG. 5, the high-side control signal UG has a positive correlation with the first control signal PWMH. Therefore, in the cases where the high-side control signal UG is used to control the discharge switch SW1, a fast discharge path for the PWM signal PWM can be also formed during the period when the PWM signal PWM is in the process of transitioning from the high logic mode to the high-impedance logic mode (i.e., the time period t2).

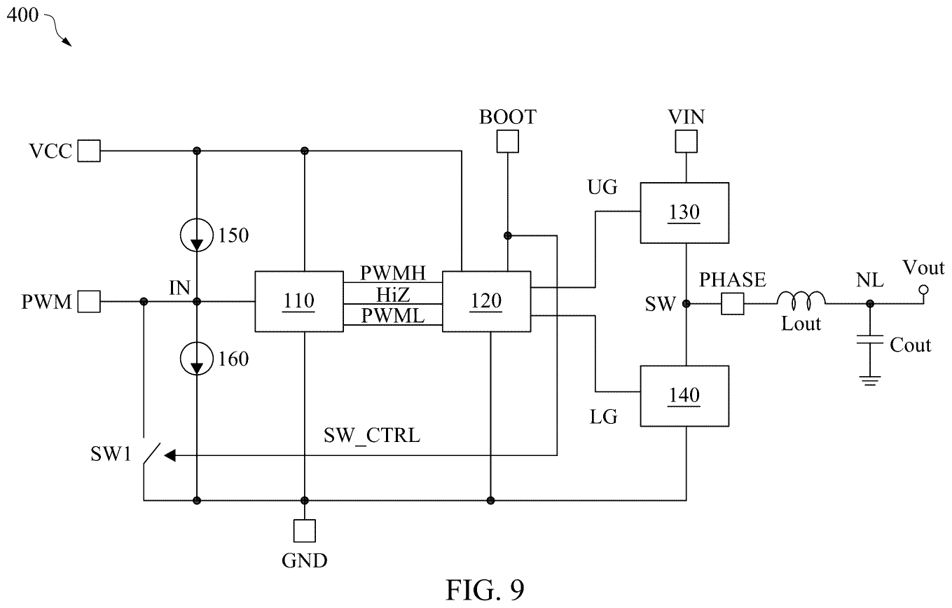

FIG. 9 is a circuit diagram of a voltage converting circuit 400 according to another embodiment of the present disclosure. The voltage converting circuit 400 is similar to the voltage converting circuit 200C. The distinction between the voltage converting circuits 400 and 200C is that the bootstrap power signal BOOT in the voltage converting circuit 400 is used as the switch control signal SW_CTRL to control the discharge switch SW1 (i.e., the switch control signal SW_CTRL of the discharge switch SW1 is the bootstrap power signal BOOT). When the bootstrap power signal BOOT is at a high level, the discharge switch SW1 is turned on to form a discharge path between the input node IN and the ground terminal GND, and the above-mentioned discharge path serves as a fast discharge path for the PWM signal PWM. It is worth mentioning that the bootstrap power signal BOOT is a signal which is generated by boost-coupling of the phase output signal PHASE at the switching node SW (e.g., the bootstrap power signal BOOT may be generated based on the phase output signal PHASE through some known signal processing manners, but the present disclosure is not limited thereto and the related description is omitted). Therefore, as shown in FIG. 5, the waveform of the bootstrap power signal BOOT is basically consistent with that of the phase output signal PHASE. Specifically, as shown in FIG. 9, the bootstrap power signal BOOT is used to directly control the on/off state of the discharge switch SW1, that is, the discharge switch SW1 is directly controlled by the bootstrap power signal BOOT. Specifically, as shown in FIG. 5, the bootstrap power signal BOOT has a positive correlation with the first control signal PWMH. Therefore, in the cases where the bootstrap power signal BOOT is used to control the discharge switch SW1, a fast discharge path for the PWM signal PWM can be also formed during the period when the PWM signal PWM is in the process of transitioning from the high logic mode to the high-impedance logic mode (i.e., the time period t2).

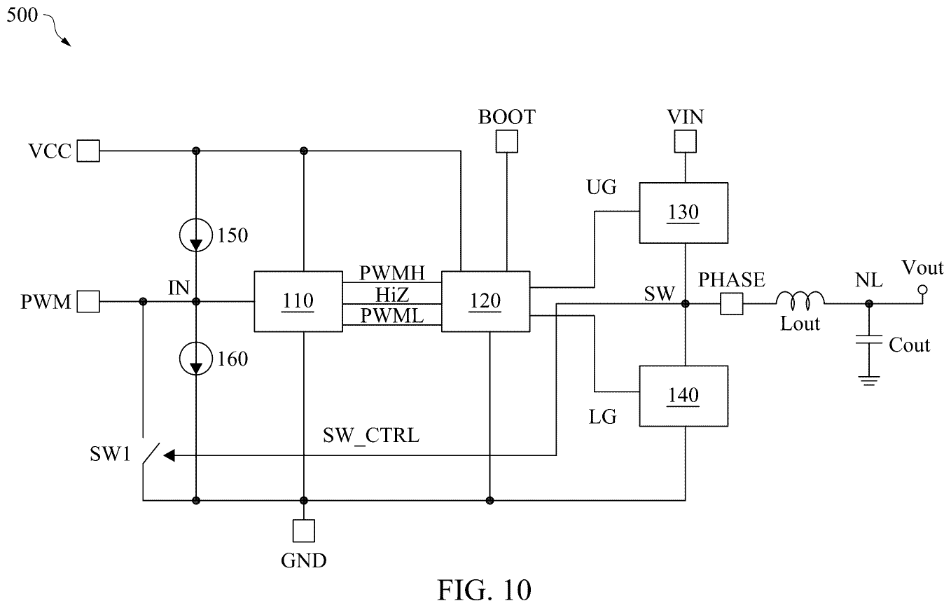

FIG. 10 is a circuit diagram of a voltage converting circuit 500 according to another embodiment of the present disclosure. The voltage converting circuit 500 is similar to the voltage converting circuit 200C. The distinction between the voltage converting circuits 500 and 200C is that the phase output signal PHASE in the voltage converting circuit 500 is used as the switch control signal SW_CTRL to control the discharge switch SW1 (i.e., the switch control signal SW_CTRL of the discharge switch SW1 is the phase output signal PHASE). When the phase output signal PHASE is at a high level, the discharge switch SW1 is turned on to form a discharge path between the input node IN and the ground terminal GND, and the above-mentioned discharge path serves as a fast discharge path for the PWM signal PWM. Specifically, as shown in FIG. 10, the phase output signal PHASE is used to directly control the on/off state of the discharge switch SW1, that is, the discharge switch SW1 is directly controlled by the phase output signal PHASE. Specifically, as shown in FIG. 5, the phase output signal PHASE has a positive correlation with the first control signal PWMH. Therefore, in the cases where the phase output signal PHASE is used to control the discharge switch SW1, a fast discharge path for the PWM signal PWM can be also formed during the period when the PWM signal PWM is in the process of transitioning from the high logic mode to the high-impedance logic mode (i.e., the time period t2).

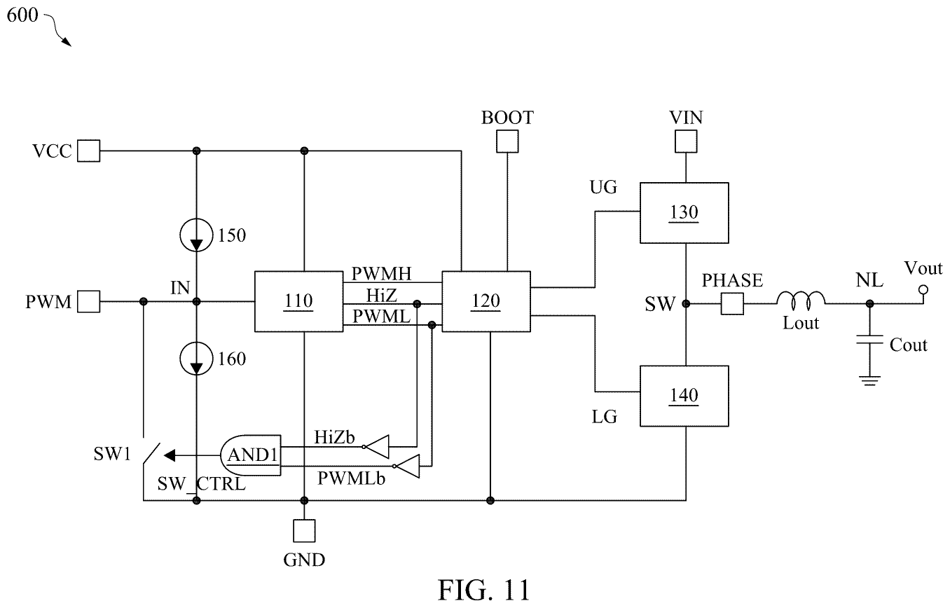

FIG. 11 is a circuit diagram of a voltage converting circuit 600 according to another embodiment of the present disclosure. The voltage converting circuit 600 is similar to the voltage converting circuit 200C. The distinction between the voltage converting circuits 600 and 200C is that an inversion of the second control signal PWML in the voltage converting circuit 600 is used as the switch control signal SW_CTRL to control the discharge switch SW1. Specifically, as shown in FIG. 5, the second control signal PWML has a negative correlation with the first control signal PWMH during the time period t2 and before the time period t2 (i.e., before the PWM signal PWM is switched to the high-impedance logic mode). Therefore, in the cases where the inversion of the second control signal PWML (i.e., a control signal PWMLb) is used to control the discharge switch SW1, a fast discharge path for the PWM signal PWM can be also formed during the period when the PWM signal PWM is in the process of transitioning from the high logic mode to the high-impedance logic mode (i.e., the time period t2). It should be noted that, as shown in FIG. 11, the voltage converting circuit 600 further includes a first AND gate AND1. The first AND gate AND1 is coupled to the discharge switch SW1. The first AND gate AND1 is used to perform an AND logic operation on the inversion of the second control signal PWML (i.e., the control signal PWMLb) and an inversion of the third control signal HiZ (i.e., a control signal HiZb) and output the switch control signal SW_CTRL to the discharge switch SW1 according to the result of the AND logic operation, thereby controlling the on/off state of the discharge switch SW1.

As shown in FIG. 11 and FIG. 5, during the time periods t1 and t2, both the second control signal PWML and the third control signal HiZ are at the low level, so that a result of the AND logic operation which is performed on the inversion of the second control signal PWML (i.e., the control signal PWMLb) and the inversion of the third control signal HiZ (i.e., the control signal HiZb) indicates a high level (i.e., the switch control signal SW_CTRL is at the high level). Therefore, the discharge switch SW1 is turned on to form a fast discharge path for the PWM signal PWM. It can be seen that when the PWM signal PWM is not driven by the front stage circuit and is in the process of transitioning from the high logic mode to the high-impedance logic mode (i.e., the time period t2), the discharge switch SW1 is turned on to form the fast discharge path for the PWM signal PWM, thereby increasing the rate at which the voltage value of the PWM signal PWM drops.

On the other hand, during the time period t3, the second control signal PWML is still at the low level, while the third control signal HiZ has changed to the high level. Therefore, a result of the AND logic operation which is performed on the inversion of the second control signal PWML (i.e., the control signal PWMLb) and the inversion of the signal HiZ (i.e., the control signal HiZb) indicates a low level (i.e., the switch control signal SW_CTRL is at the low level), and thus the discharge switch SW1 is turned off to disconnect the fast discharge path for the PWM signal PWM. Specifically, during the time period t3, the inversion of the second control signal PWML (i.e., the control signal PWMLb) is still at the high level. In design, it is desired to turn off the discharge switch SW1 during the time period t3 so that the PWM signal PWM can remain in the high-impedance logic mode. Therefore, the voltage converting circuit 600 performs the AND logic operation on to the inversion of the second control signal PWML (i.e., the control signal PWMLb) and the inversion of the third control signal HiZ (i.e., the control signal HiZb), so that the switch control signal SW_CTRL is at the low level during the time period t3, thereby turning off the discharge switch SW1.

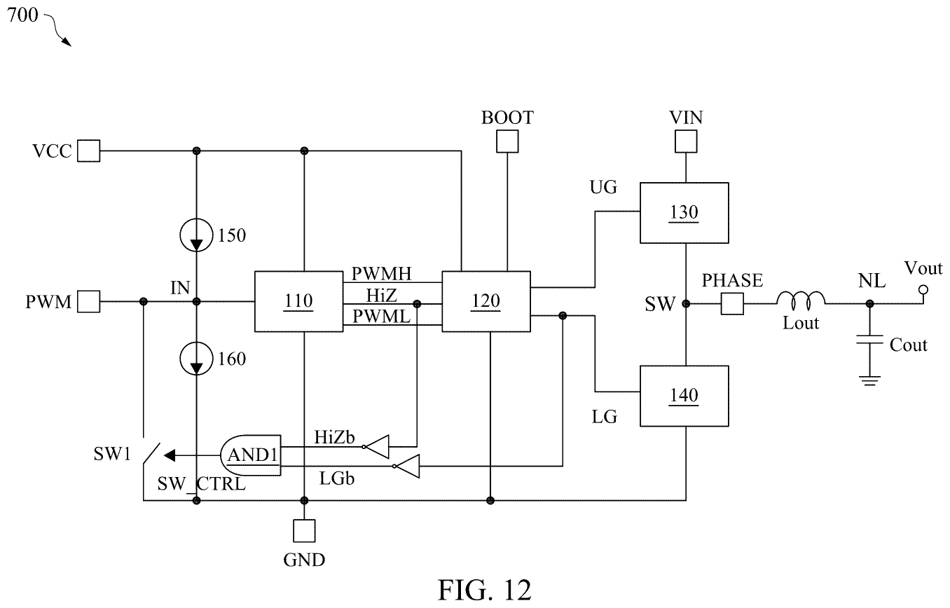

FIG. 12 is a circuit diagram of a voltage converting circuit 700 according to another embodiment of the present disclosure. The voltage converting circuit 700 is similar to the voltage converting circuit 600. The distinction between the voltage converting circuits 700 and 600 is that one of the input signals of the first AND gate AND1 in the voltage converting circuit 700 is replaced by an inversion of the low-side control signal LG (i.e., a control signal LGb). The inversion of the low-side control signal LG is used as the switch control signal SW_CTRL to control the discharge switch SW1. Specifically, as shown in FIG. 5, the low-side control signal LG has a positive correlation with the second control signal PWML. Therefore, in the cases where the inversion of the low-side control signal LG (i.e., the control signal LGb) is used to control the discharge switch SW1, a fast discharge path for the PWM signal PWM can be also formed during the period when the PWM signal PWM is in the process of transitioning from the high logic mode to the high-impedance logic mode (i.e., the time period t2). It should be noted that, as shown in FIG. 12, the voltage converting circuit 700 further includes a first AND gate AND1. The first AND gate AND1 is coupled to the discharge switch SW1. The first AND gate AND1 is used to perform an AND logic operation on the inversion of the low-side control signal LG (i.e., the control signal LGb) and the inversion of the third control signal HiZ (i.e., the control signal HiZb) and output the switch control signal SW_CTRL to the discharge switch SW1 according to the result of the AND logic operation, thereby controlling the on/off state of the discharge switch SW1.

As shown in FIG. 12 and FIG. 5, during the time periods t1 and t2, both the low-side control signal LG and the third control signal HiZ are at the low level, so that a result of the AND logic operation which is performed on the inversion of the low-side control signal LG (i.e., the control signal LGb) and the inversion of the third control signal HiZ (i.e., the control signal HiZb) indicates a high level (i.e., the switch control signal SW_CTRL is at the high level). Therefore, the discharge switch SW1 is turned on to form a fast discharge path for the PWM signal PWM. It can be seen that when the PWM signal PWM is not driven by the front stage circuit and is in the process of transitioning from the high logic mode to the high-impedance logic mode (i.e., the time period t2), the discharge switch SW1 is turned on to form the fast discharge path for the PWM signal PWM, thereby increasing the rate at which the voltage value of the PWM signal PWM drops.

On the other hand, during the time period t3, the inversion of the low-side control signal LG (i.e., the control signal LGb) is still at a high level. In design, it is desired to turn off the discharge switch SW1 during the time period t3, so that the PWM signal PWM can remain in the high-impedance logic mode. Therefore, the voltage converting circuit 700 performs the AND logic operation on the inversion of the low-side control signal LG (i.e., the control signal LGb) and the inversion of the third control signal HiZ (i.e., the control signal HiZb), so that the switch control signal SW_CTRL is at the low level during the time period t3, thereby turning off the discharge switch SW1.

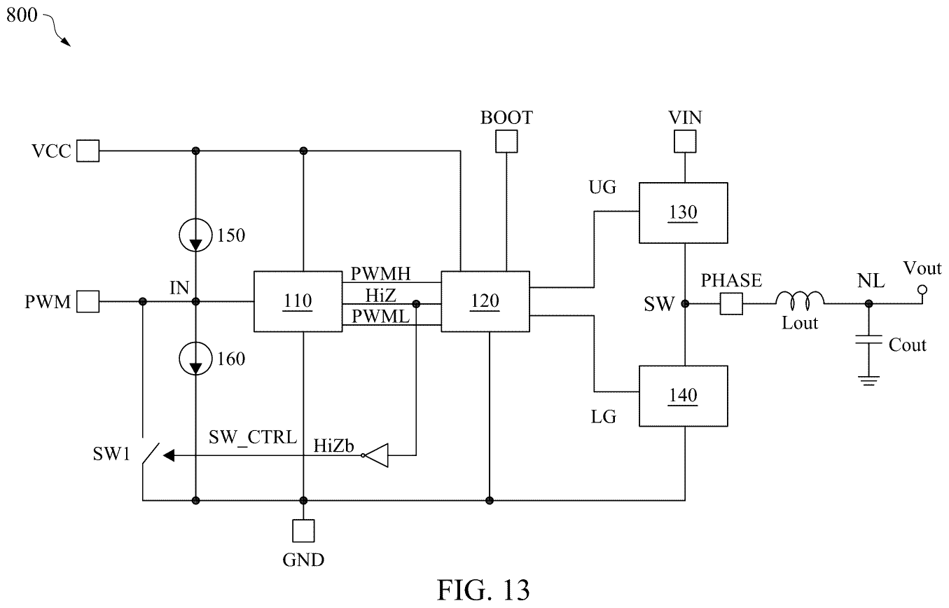

FIG. 13 is a circuit diagram of a voltage converting circuit 800 according to another embodiment of the present disclosure. The voltage converting circuit 800 is similar to the voltage converting circuit 200C. The distinction between the voltage converting circuits 800 and 200C is that the inversion of the third control signal HiZ in the voltage converting circuit 800 is used as the switch control signal SW_CTRL to control the discharge switch SW1. Specifically, as shown in FIG. 13, the inversion of the third control signal HiZ is used to directly control the on/off state of the discharge switch SW1, that is, the discharge switch SW1 is directly controlled by the inversion of the third control signal HiZ. Specifically, as shown in FIG. 5, the third control signal HiZ has a negative correlation with the first control signal PWMH in the time periods t1, t2, and t3. Therefore, in the cases where the inversion of the third control signal HiZ (i.e., the control signal HiZb) is used to control the discharge switch SW1, a fast discharge path for the PWM signal PWM can be also formed during the period when the PWM signal PWM is in the process of transitioning from the high logic mode to the high-impedance logic mode (i.e., the time period t2).

As shown in FIG. 13 and FIG. 5, during the time periods t1 and t2, the third control signal HiZ is at the low level, so that the inversion of the third control signal HiZ is at the high level (i.e., the switch control signal SW_CTRL is at the high level). Therefore, the discharge switch SW1 is turned on to form a fast discharge path for the PWM signal PWM. It can be seen that when the PWM signal PWM is not driven by the front stage circuit and is in the process of transitioning from the high logic mode to the high-impedance logic mode (i.e., the time period t2), the discharge switch SW1 is turned on to form the fast discharge path for the PWM signal PWM, thereby increasing the rate at which the voltage value of the PWM signal PWM drops. On the other hand, during the time period t3, the inversion of the third control signal HiZ (i.e., the control signal HiZb) has changed to the low level (i.e., the switch control signal SW_CTRL is at the high level), thereby turning off the discharge switch SW1.

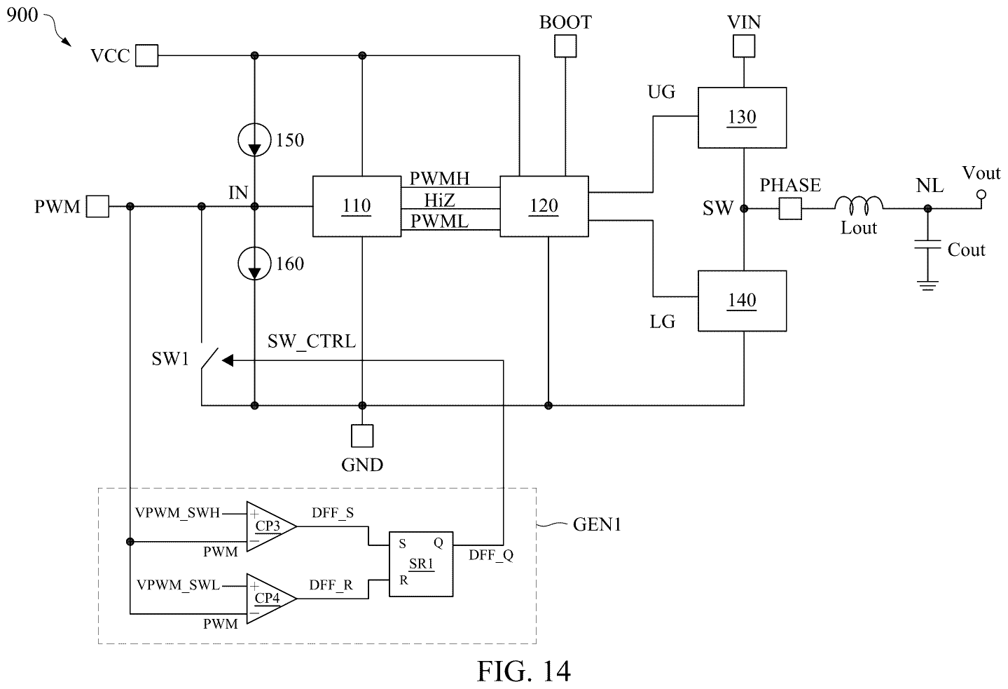

FIG. 14 is a circuit diagram of a voltage converting circuit 900 according to another embodiment of the present disclosure. The voltage converting circuit 900 is similar to the voltage converting circuit 200C. The distinction between the voltage converting circuits 900 and 200C is that the discharge switch SW1 of the voltage converting circuit 900 is controlled by the PWM signal PWM. Specifically, as shown in FIG. 5, the PWM signal PWM has a positive correlation with the first control signal PWMH (in view of a digital signal) in the time periods t1 and t2. Therefore, in the cases where the PWM signal PWM is used to control the discharge switch SW1, a fast discharge path for the PWM signal PWM can also be formed during the period when the PWM signal PWM is in the process of transitioning from the high logic mode to the high-impedance logic mode (i.e., the time period t2).

It should be noted that, as shown in FIG. 14, the voltage converting circuit 900 further includes a level generating circuit GEN1. The level generating circuit GEN1 is coupled to the input node IN. The level generating circuit GEN1 receives the PWM signal PWM and outputs a switch conducting signal DFF_Q according to the level of the PWM signal PWM. Thus, the switch conducting signal DFF_Q is correlated with the level of the PWM signal PWM. In some embodiments with respect to FIG. 14, the switch conducting signal DFF_Q is used as the switch control signal SW_CTRL of the discharge switch SW1. The level generating circuit GEN1 includes a third comparator CP3, a fourth comparator CP4, and an SR flip-flop SR1. A negative input terminal (labelled as “−” in FIG. 14) of the third comparator CP3 and a negative input terminal of the fourth comparator CP4 receive the PWM signal PWM. A positive input terminal (labelled as “+” in FIG. 14) of the third comparator CP3 receives a second high input threshold voltage VPWM_SWH, and a positive input terminal of the fourth comparator CP4 receives a second low input threshold voltage VPWM_SWL. The third comparator CP3 compares the PWM signal PWM with the second high input threshold voltage VPWM_SWH and outputs a first comparing signal DFF_S according to the comparison result between the PWM signal PWM and the second high input threshold voltage VPWM_SWH. The fourth comparator CP4 compares the PWM signal PWM with the second low input threshold voltage VPWM_SWL and outputs a second comparing signal DFF_R according to the comparison result between the PWM signal PWM and the second low input threshold voltage VPWM_SWL. A setting terminal (labelled as “S” in FIG. 14) of the SR flip-flop SR1 is coupled to an output terminal of the third comparator CP3 to receive the first comparing signal DFF_S. A reset terminal (labelled as “R” in FIG. 14) of the SR flip-flop SR1 is coupled to an output terminal of the fourth comparator CP4 to receive the second comparing signal DFF_R. The SR flip-flop SR1 outputs the switch conducting signal DFF_Q at an output terminal (labelled as “Q” in FIG. 14) of the SR flip-flop SR1 according to the first comparing signal DFF_S and the second comparing signal DFF_R. Therefore, it can be seen that, as shown in FIG. 14, the switch conducting signal DFF_Q is used to directly control the on/off state of the discharge switch SW1, that is, the discharge switch SW1 is directly controlled by the switch conducting signal DFF_Q.

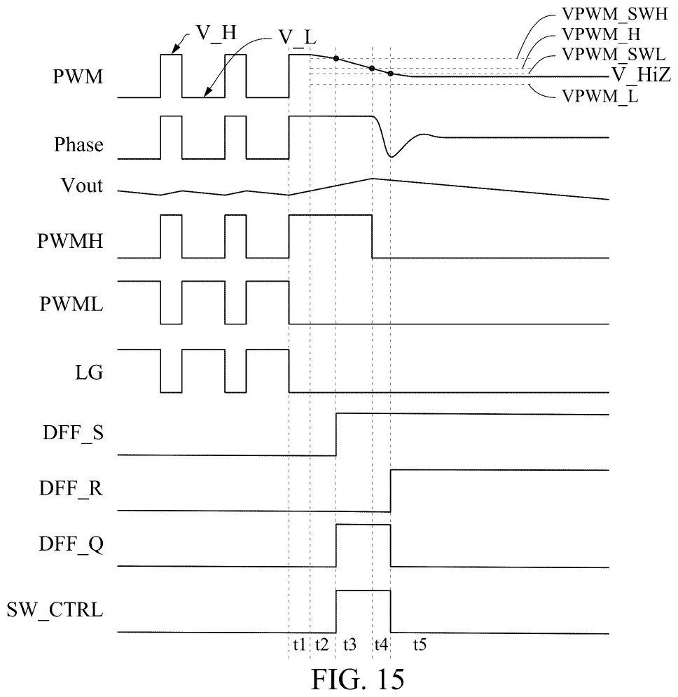

FIG. 15 is a timing chart of various signals of the voltage converting circuit 900 (also applicable to voltage converting circuits 1000 and 1100 which will be described later). As shown in FIG. 15, the second high input threshold voltage VPWM_SWH is lower than the high logic level V_H of the PWM signal PWM and is higher than the first high input threshold voltage VPWM_H. The second low input threshold voltage VPWM_SWL is lower than the first high input threshold voltage VPWM_H and is higher than the high-impedance logic level V_HiZ of the PWM signal PWM. Within the above-mentioned voltage ranges, the voltage values of the second high input threshold voltage VPWM_SWH and the second low input threshold voltage VPWM_SWL can be determined according to actual requirements.

As shown in FIG. 14 and FIG. 15, during the time periods t1 and t2, the voltage value of the PWM signal PWM is higher than the second high input threshold voltage VPWM_SWH and the second low input threshold voltage VPWM_SWL, and, thus, the first comparing signal DFF_S and the second comparing signal DFF_R are both at a low level, so that the switch conducting signal DFF_Q is also at a low level (i.e., the switch control signal SW_CTRL is at the low level), thereby turning off the discharge switch SW1. At this time, it is determined that the PWM signal PWM is in the high logic mode. As shown in FIG. 14 and FIG. 15, during the time period t5, the voltage value of the PWM signal PWM is lower than the second high input threshold voltage VPWM_SWH and the second low input threshold voltage VPWM_SWL, and therefore the first comparing signal DFF_S and the second comparing signal DFF_R are both at a high level, so that the switch conducting signal DFF_Q is at the low level (i.e., the switch control signal SW_CTRL is at the low level), thereby turning off the discharge switch SW1. At this time, it is determined that the PWM signal PWM is in the high-impedance logic mode. As shown in FIG. 15, during the time period t5, the voltage value of the PWM signal PWM decreases from the second low input threshold voltage VPWM_SWL to the high-impedance logic level V_HiZ of the PWM signal PWM and then remains at the high-impedance logic level V_HiZ of the PWM signal PWM. Since the second low input threshold voltage VPWM_SWL is defined to be lower than the first high input threshold voltage VPWM_H and to be higher than the high-impedance logic level V_HiZ of the PWM signal PWM, the PWM signal PWM is at the high-impedance logic mode during the time period t5.

During the time periods t3 and t4, since the voltage value of the PWM signal PWM is lower than the second high input threshold voltage VPWM_SWH and further higher than the second low input threshold voltage VPWM_SWL, the first comparing signal DFF_S is at the high level and the second comparing signal DFF_R is at the low level, so that the switch conducting signal DFF_Q changes to a high level (i.e., the switch control signal SW_CTRL is at the high level), thereby turning on the discharge switch SW1 to form a fast discharge path for the PWM signal PWM.

In other words, during the time periods t3 and t4, the voltage value of the PWM signal PWM is pulled down by not only the sink current of the current sink 160 but also the fast discharge path formed by the discharge switch SW1. As shown in FIG. 14 and FIG. 15, the rate at which the voltage value of the PWM signal PWM of the voltage converting circuit 900 drops is increased during the time periods t3 and t4 (i.e., the slope by which the PWM signal PWM drops during the time periods t3 and t4 is greater than the slope by which the PWM signal PWM drops during the time periods t2 and t5), thereby shortening the duration of the time periods t3 and t4 (i.e., the conducting time of the high-side switch 130 is shortened). Therefore, the output voltage Vout and the current of the output inductor Lout are not too large, thereby avoiding damage to the high-side switch 130. It should be noted that, as shown in FIG. 15, when the PWM signal PWM is in the process of transitioning from the high logic mode to the high-impedance logic mode (i.e., the time period t3), the discharge switch SW1 is turned on according the switch control signal SW_CTRL to form a fast discharge path for the PWM signal PWM. During the time period t4, the voltage value of the PWM signal PWM drops to be lower than the first high input threshold voltage VPWM_H, and, therefore, the PWM signal PWM enters the high-impedance logic mode. As shown in the time period t5 of FIG. 15, the PWM signal PWM is in the high-impedance logic mode. In addition, after the PWM signal PWM drops to the second low input threshold voltage VPWM_SWL, the discharge switch SW1 is switched to the turned-off state (i.e., the switch control signal SW_CTRL switches to be in the low level).

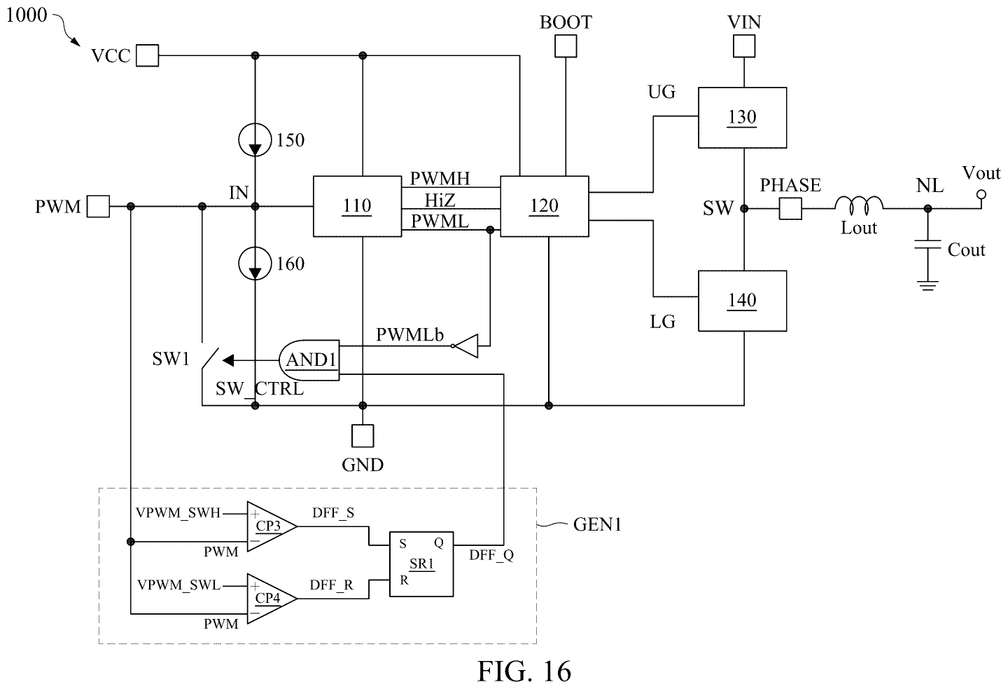

FIG. 16 is a circuit diagram of a voltage converting circuit 1000 according to another embodiment of the present disclosure. The voltage converting circuit 1000 is similar to the voltage converting circuit 600. The distinction between the voltage converting circuits 1000 and 600 is that one of the input signals of the first AND gate AND1 of the voltage converting circuit 1000 is replaced by the switch conducting signal DFF_Q from the inversion of the third control signal HiZ. The first AND gate AND1 performs the AND logic operation on the inversion of the second control signal PWML (i.e., the control signal PWMLb) and the switch conducting signal DFF_Q, thereby outputting the switch control signal SW_CTRL to the discharge switch SW1 to control the on/off state of the discharge switch SW1.

As shown in FIG. 16 and FIG. 15, during the time periods t1 and t2, both the second control signal PWML and the switch conducting signal DFF_Q are at the low level, so that a result of the AND logic operation which is performed on to the inversion of the second control signal PWML (i.e., the control signal PWMLb) and the switch conducting signal DFF_Q indicates a low level (i.e., the switch control signal SW_CTRL is at the low level), thereby turning off the discharge switch SW1. During the time periods t3 and t4, the second control signal PWML is at the low level and the switch conducting signal DFF_Q is at the high level, so that a result of the AND logic operation which is performed on the inversion of the second control signal PWML (i.e., the control signal PWMLb) and the switch conducting signal DFF_Q indicates a high level (i.e., the switch control signal SW_CTRL is at the high level). Therefore, the discharge switch SW1 is turned on to form the fast discharge path for the PWM signal PWM. In other words, during the time periods t3 and t4, the second control signal PWML is at the low level, and the discharge switch SW1 is turned on to form the fast discharge path for the PWM signal PWM.

On the other hand, during the time period t5, the second control signal PWML is still at the low level, while the switch conducting signal DFF_Q has changed to the low level, so that a result of the AND logic operation which is performed on the inversion of the second control signal PWML (i.e., the control signal PWMLb) and the switch conducting signal DFF_Q indicates a low level (i.e., the switch control signal SW_CTRL is at the low level), thereby turning off the discharge switch SW1 to disconnect the fast discharge path for the PWM signal PWM. Specifically, during the time period t5, the inversion of the second control signal PWML (i.e., the control signal PWMLb) is still at the high level. In design, it is desired to turn off the discharge switch SW1 during the time period t5, so that the PWM signal PWM can remain in the high-impedance logic mode. Therefore, the voltage converting circuit 1000 performs the AND logic operation on the inversion of the second control signal PWML (i.e., the control signal PWMLb) and the switch conducting signal DFF_Q, so that the switch control signal SW_CTRL is at the low level during the time period t5, thereby turning off the discharge switch SW1.

In another embodiment, the first AND gate AND1 can receive the inversion of the second control signal PWML (i.e., the control signal PWMLb), the inversion of the third control signal HiZ (i.e., the control signal HiZb), and the switch conducting signal DFF_Q, and further perform an AND logic operation on the above-mentioned signals. Therefore, it can be seen that when the PWM signal PWM is in the high-impedance logic mode, once the inversion of the third control signal HiZ (i.e., the control signal HiZb) or the switch conducting signal DFF_Q switches to the respective low level, the first AND gate AND1 correspondingly outputs the switch control signal SW_CTRL with the low level, thereby turning off the discharging switch SW1.

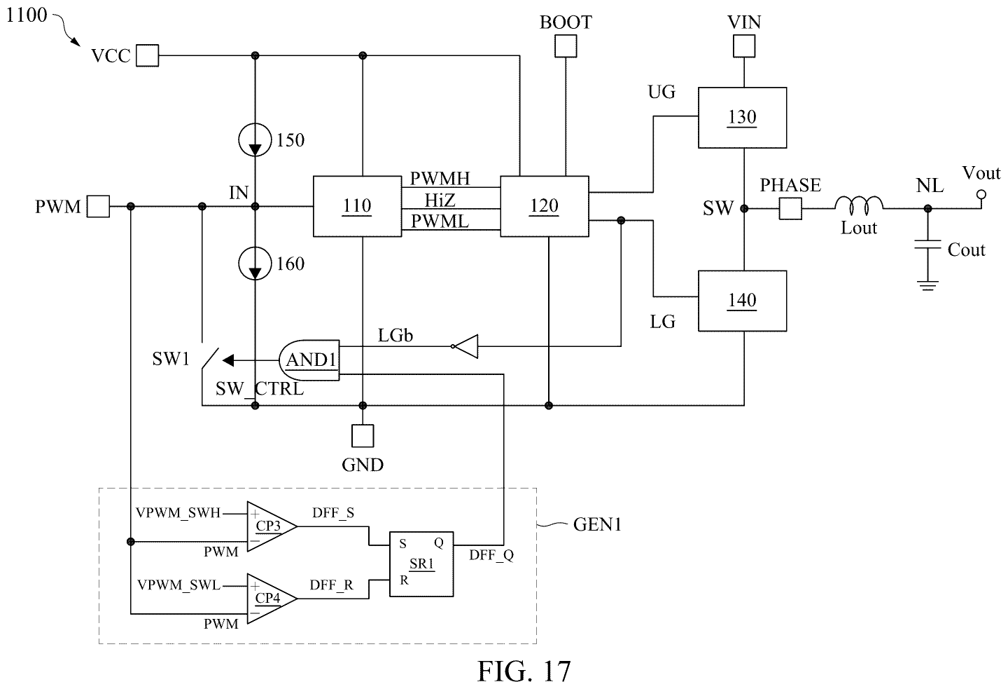

FIG. 17 is a circuit diagram of a voltage converting circuit 1100 according to another embodiment of the present disclosure. The voltage converting circuit 1100 is similar to the voltage converting circuit 700. The distinction between the voltage converting circuits 1100 and 700 is, except that one of the input signals of the first AND gate AND1 of the voltage converting circuit 1100 is replaced by the switch conducting signal DFF_Q from the inversion of the third control signal HiZ. The first AND gate AND1 performs the AND logic operation on the inversion of the low-side control signal LG (i.e., the control signal LGb) and the switch conducting signal DFF_Q, thereby outputting the switch control signal SW_CTRL to the discharge switch SW1 to control the on/off state of the discharge switch SW1.

As shown in FIG. 17 and FIG. 15, during the time periods t1 and t2, both the low-side control signal LG and the switch conducting signal DFF_Q are at a low level, so that a result of the AND logic operation which is performed on the inversion of the low-side control signal LG (i.e., the control signal LGb) and the switch conducting signal DFF_Q indicates a low level (i.e., the switch control signal SW_CTRL is at the low level), thereby turning off the discharge switch SW1. During the time periods t3 and t4, the low-side control signal LG is at the low level and the switch conducting signal DFF_Q is at the high level, so that a result of the AND logic operation which is performed on the inversion of the low-side control signal LG (i.e., the control signal LGb) and the switch conducting signal DFF_Q indicates a high level (i.e., the switch control signal SW_CTRL is at the high level). Therefore, the discharge switch SW1 is turned on to form the fast discharge path for the PWM signal PWM. In other words, during the time periods t3 and t4, the low-side control signal LG is at the low level, and the discharge switch SW1 is turned on to form the fast discharge path for the PWM signal PWM.

On the other hand, during the time period t5, the low-side control signal LG is still at the low level, while the switch conducting signal DFF_Q has changed to the low level, so that a result of the AND logic operation which is performed on the inversion of the low-side control signal LG (i.e., the control signal LGb) and the switch conducting signal DFF_Q indicates a low level (i.e., the switch control signal SW_CTRL is at the low level), thereby turning off the discharge switch SW1 to disconnect the fast discharge path for the PWM signal PWM. Specifically, during the time period t5, the inversion of the low-side control signal LG (i.e., the control signal LGb) is still at the high level. In design, it is desired to turn off the discharge switch SW1 during the time period t5, so that the PWM signal PWM can remain in the high-impedance logic mode. Therefore, the voltage converting circuit 1100 performs the AND logic operation on the inversion of the low-side control signal LG (i.e., the control signal LGb) and the switch conducting signal DFF_Q, so that the switch control signal SW_CTRL is at the low level during the time period t5, thereby turning off the discharge switch SW1.

In another embodiment, the first AND gate AND1 can receive the inversion of the low-side control signal LG (i.e., the control signal LGb), the inversion of the third control signal HiZ (i.e., the control signal HiZb), and the switch conducting signal DFF_Q, and further perform an AND logic operation on the above-mentioned signals. Therefore, it can be seen that when the PWM signal PWM is in the high-impedance logic mode, once the inversion of the third control signal HiZ (i.e., the control signal HiZb) or the switch conducting signal DFF_Q switches to the respective low level, the first AND gate AND1 correspondingly outputs the switch control signal SW_CTRL with the low level, thereby turning off the discharging switch SW1.

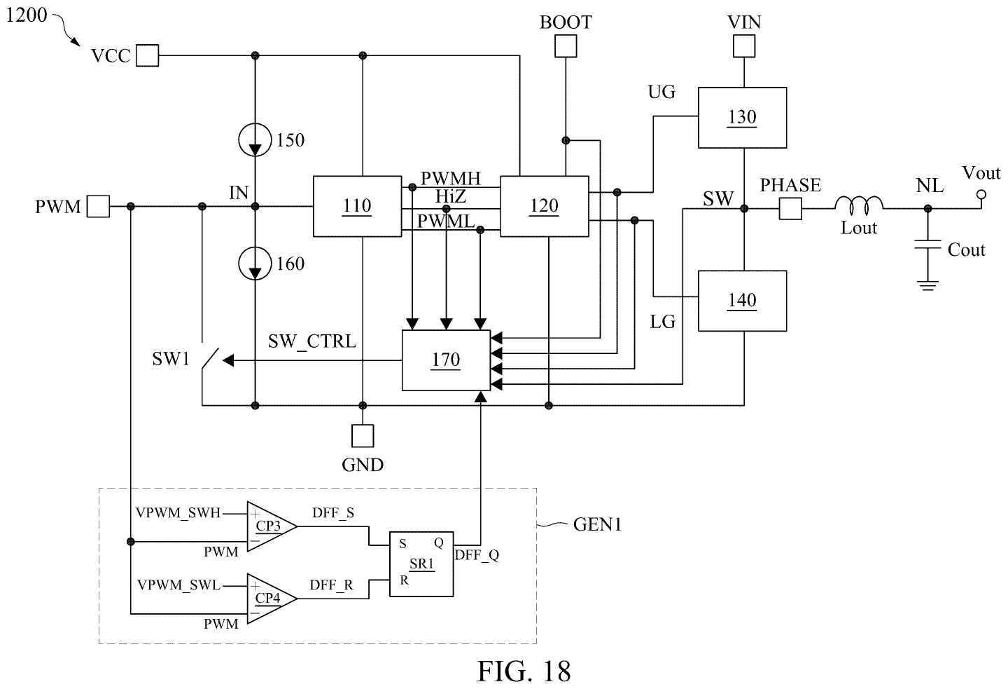

FIG. 18 is a circuit diagram of a voltage converting circuit 1200 according to another embodiment of the present disclosure. The voltage converting circuit 1200 is similar to the voltage converting circuit 900. The distinction between the voltage converting circuits 1200 and 900 is that the voltage converting circuit 1200 further includes a switch control circuit 170 which is coupled to the discharge switch SW1. The switch control circuit 170 outputs the switch control signal SW_CTRL to the discharge switch SW1 to control the on/off state of the discharge switch SW1.

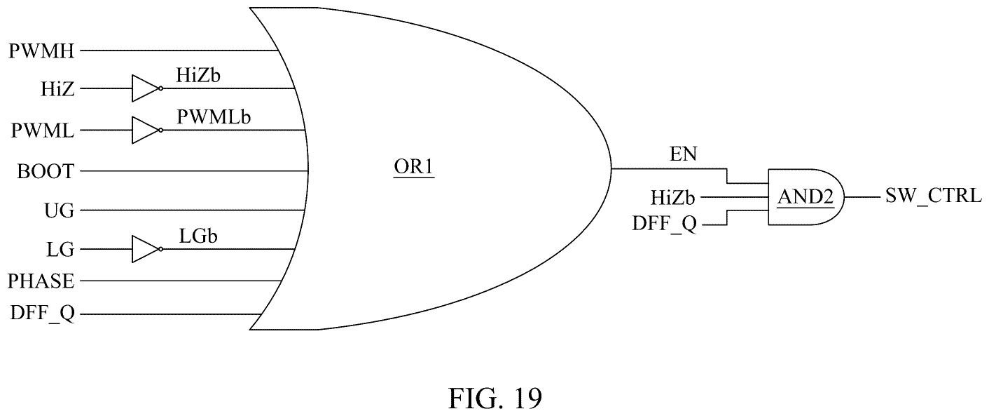

FIG. 19 is a circuit diagram of the switch control circuit 170 according to an embodiment of the present disclosure. The switch control circuit 170 includes an OR gate OR1 and a second AND gate AND2. The OR gate OR1 receives a plurality of input signals including the first control signal PWMH, the inversion of the third control signal HiZ (i.e., the control signal HiZb), the inversion of the second control signal PWML (i.e., the control signal PWMLb), the bootstrap power signal BOOT, the high-side control signal UG, the inversion of the low-side control signal LG (i.e., the control signal LGb), the phase output signal PHASE, and the switch conducting signal DFF_Q, and further performs an OR logic operation on the above-mentioned signals, thereby outputting an enable signal EN. It is worth mentioning that the input signals of the OR gate OR1 as shown in FIG. 19 are only illustrative, and the present disclosure is not limited thereto. At least one of the input signals of the OR gate OR1 as shown in FIG. 19 can also be deleted according to actual requirements. The second AND gate AND2 is coupled to the OR gate OR1 to receive the enable signal EN. The second AND gate AND2 performs an AND logic operation on the enable signal EN, the inversion of the third control signal HiZ (i.e., the control signal HiZb), and the switch conducting signal DFF_Q, thereby outputting the switch control signal SW_CTRL.

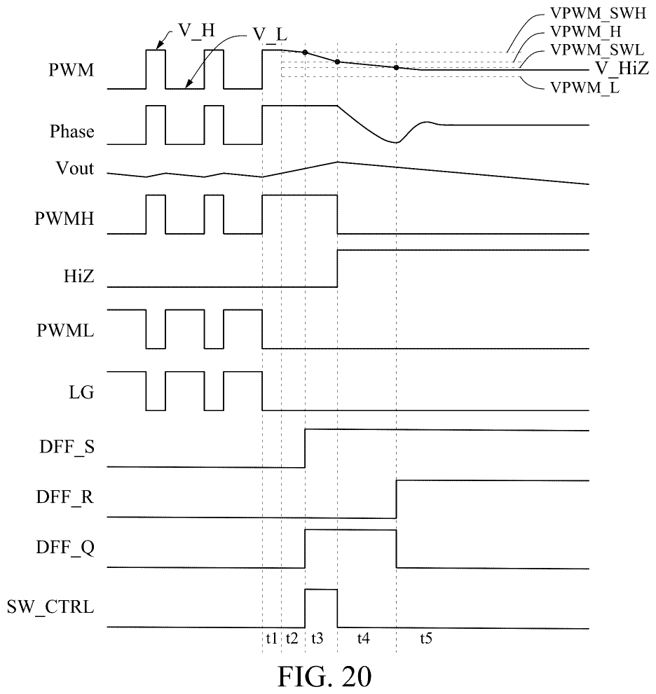

FIG. 20 is a timing chart of various signals of the voltage converting circuit 1200. As shown in FIG. 18, FIG. 19, and FIG. 20, during time periods t1 and t2, the enable signal EN outputted by the OR gate OR1 of the switch control circuit 170 may have a high level because the control signal PWMLb is at the high level. However, because the switch conducting signal DFF_Q is at the low level, the switch control signal SW_CTRL outputted by the second AND gate AND2 of the switch control circuit 170 is at the low level, and the discharge switch SW1 is turned off. As shown in FIG. 18, FIG. 19, and FIG. 20, during the time period t3, the enable signal EN may have the high level because the control signal PWMLb is at the high level, and the switch control signal SW_CTRL outputted by the second AND gate AND2 of the switch control circuit 170 is at the high level because the switch conducting signal DFF_Q is at the high level and the control signal HiZb is at the high level (as mentioned above, during the time period t3, the PWM signal PWM is higher than the first high input threshold voltage VPWM_H, so that the third control signal HiZ is at the low level), so that the discharge switch SW1 is turned on to form the fast discharge path for the PWM signal PWM. During the time periods t4 and t5, the enable signal EN may have a high level because the control signal PWMLb is at the high level. However, because at least one of the switch conduction signal DFF_Q and the control signal HiZb is at the respective low level (as mentioned above, during the time period t4, the voltage value of the PWM signal PWM drops to be lower than the first high input threshold voltage VPWM_H and high than the first low input threshold voltage VPWM_L, so that the third control signal HiZ switches to the high level at the time point between the time periods t3 and t4, that is, the control signal HiZb switches to the low level), the switch control signal SW_CTRL outputted by the second AND gate AND2 is at the low level, thereby turning off the discharge switch SW1. Specifically, during the time period t4, the control signal HiZb is at the low level; during the time period t5, the switch conducting signal DFF_Q and the control signal HiZb are both at the respective low levels. Therefore, during time periods t4 and t5, based on the operation of the second AND gate AND2, at least one of the switch conducting signal DFF_Q and the control signal HiZb is at the respective low level, and thus the switch control signal SW_CTRL is at the low level.

According to some embodiments with respect to FIG. 18, FIG. 19, and FIG. 20, the second AND gate AND2 is coupled to the OR gate OR1 to receive the enable signal EN. The second AND gate AND2 further receives the inversion of the third control signal HiZ (i.e., the control signal HiZb) and the switch conducting signal DFF_Q. The second AND gate AND2 performs the AND logic operation on the enable signal EN, the control signal HiZb, and the switch conducting signal DFF_Q. Therefore, it can be seen that when the PWM signal PWM is in the high-impedance logic mode, once the inversion of the third control signal HiZ (i.e., the control signal HiZb) or the switch conducting signal DFF_Q switches to the respective low level, the second AND gate AND2 outputs the switch control signal SW_CTRL with the low level, thereby turning off the discharging switch SW1.

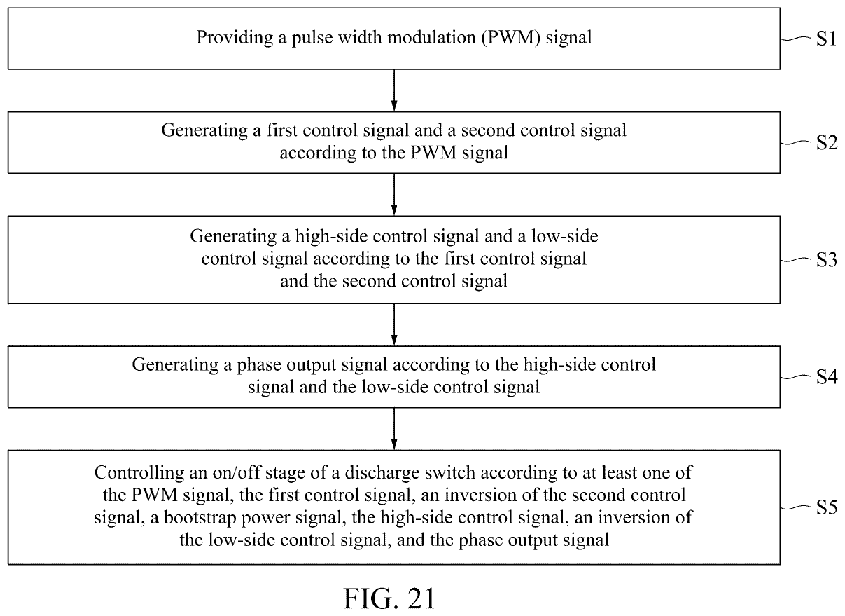

FIG. 21 is a flow chart of a voltage converting method according to another embodiment of the present disclosure. The voltage converting method includes Steps S1 to S5. In Step S1, the input node IN provides the PWM signal PWM. In Step S2, the logic circuit 110 receives the PWM signal PWM and correspondingly outputs the first control signal PWMH and the second control signal PWML. In other words, in Step S2, the first control signal PWMH and the second control signal PWML are generated according to the PWM signal PWM. In Step S3, the driver control circuit 120 receives the first control signal PWMH and the second control signal PWML and correspondingly outputs the high-side control signal UG and the low-side control signal LG. In other words, in Step S3, the high-side control signal UG and the low-side control signal LG are generated according to the first control signal PWMH and the second control signal PWML, in which the driver control circuit 120 further receives the bootstrap power signal BOOT for driving the driver control circuit 120. A supplementary explanation for Steps S2 and S3 is that, in some embodiments, the high-side control signal UG and the low-side control signal LG may be generated without using the third control signal HiZ, so that the third control signal HiZ may be omitted. In Step S4, a control terminal of the high-side switch 130 receives the high-side control signal UG, and a control terminal of the low-side switch 140 receives the low-side control signal LG, and the phase output signal PHASE is output or generated at a first terminal of the low-side switch 140 and a second terminal of the high-side switch 130. In other words, in Step S4, the phase output signal PHASE is generated according to the high-side control signal UG and the low-side control signal LG. In Step S5, the discharge switch SW1 is controlled to be turned on or off, in which the discharge switch SW1 is coupled between the input node IN and the ground terminal GND, and the discharge switch SW1 is controlled by at least one of the PWM signal PWM, the first control signal PWMH, the inversion of the second control signal PWML, the bootstrap power signal BOOT, the high-side control signal UG, the inversion of the low-side control signal LG, and the phase output signal PHASE. In other words, in Step S5, the on/off state of the discharge switch SW1 is controlled or determined by at least one of the PWM signal PWM, the first control signal PWMH, the inversion of the second control signal PWML, the bootstrap power signal BOOT, the high-side control signal UG, the inversion of the low-side control signal LG and the phase output signal PHASE.

In some embodiments of the present disclosure, the discharge switch SW1 of one of the voltage converting circuit 300 as shown in FIG. 8, the voltage converting circuit 400 as shown in FIG. 9, the voltage converting circuit 500 as shown in FIG. 10, the voltage converting circuit 600 as shown in FIG. 11, the voltage converting circuit 700 as shown in FIG. 12, the voltage converting circuit 800 as shown in FIG. 13, the voltage converting circuit 900 as shown in FIG. 14, the voltage converting circuit 1000 as shown in FIG. 16, the voltage converting circuit 1100 as shown in FIG. 17, and the voltage converting circuit 1200 as shown in FIG. 18 can be also implemented as the discharge switch SW1 of the voltage converting circuit 200A as shown in FIG. 3, so that the discharge switch SW1 and the resistor R1 are connected in series and coupled between the input node IN and the ground terminal GND.

In some embodiments of the present disclosure, the discharge switch SW1 of one of the voltage converting circuit 300 as shown in FIG. 8, the voltage converting circuit 400 as shown in FIG. 9, the voltage converting circuit 500 as shown in FIG. 10, the voltage converting circuit 600 as shown in FIG. 11, the voltage converting circuit 700 as shown in FIG. 12, the voltage converting circuit 800 as shown in FIG. 13, the voltage converting circuit 900 as shown in FIG. 14, the voltage converting circuit 1000 as shown in FIG. 16, the voltage converting circuit 1100 as shown in FIG. 17, and the voltage converting circuit 1200 as shown in FIG. 18 can be also implemented as the discharge switch SW1 of the voltage converting circuit 200B as shown in FIG. 6, so that the discharge switch SW1 and the current sink IS1 are connected in series and coupled between the input node IN and the ground terminal GND.

To sum up, the present disclosure provides a voltage converting circuit that is used to form a fast discharge path for the PWM signal when the PWM signal is in the process of transitioning from the high logic mode to the high-impedance logic mode, so that the output voltage and the current of the output inductor are not too large, thereby avoiding damage to the high-side switch.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present disclosure cover modifications and variations of this disclosure provided they fall within the scope of the following claims.

What is claimed is:

1. A voltage converting circuit, comprising:
a logic circuit coupled to an input node to receive a pulse width modulation (PWM) signal, and configured to output a first control signal and a second control signal according to the PWM signal;
a driver control circuit coupled to the logic circuit to receive the first and second control signals, and configured to output a high-side control signal and a low-side control signal according to the first and second control signals, wherein the driver control circuit further receives a bootstrap power signal for driving the driver control circuit;
a high-side switch, wherein a control terminal of the high-side switch is coupled to the driver control circuit to receive the high-side control signal;
a low-side switch, wherein a control terminal of the low-side switch is coupled to the driver control circuit to receive the low-side control signal, wherein a first terminal of the low-side switch and a second terminal of the high-side switch are coupled to a switching node, and a phase output signal is generated at the switching node; and
a discharge switch is coupled between the input node and a ground terminal;
wherein the discharge switch is controlled by at least one of the PWM signal, the first control signal, an inversion of the second control signal, the bootstrap power signal, the high-side control signal, an inversion of the low-side control signal, and the phase output signal.

2. The voltage converting circuit of claim 1, further comprising:
a resistor, wherein the discharge switch and the resistor are connected in series between the input node and the ground terminal.

3. The voltage converting circuit of claim 1, further comprising:
a current sink, wherein the discharge switch and the current sink are connected in series between the input node and the ground terminal.

4. The voltage converting circuit of claim 1, wherein one of the first control signal, the bootstrap power signal, the high-side control signal, and the phase output signal is used for directly controlling an on/off state of the discharge switch.

5. The voltage converting circuit of claim 1, wherein the logic circuit comprises:
a first comparator configured to compare the PWM signal with a first high input threshold voltage and output the first control signal according to a comparison result between the PWM signal and the first high input threshold voltage; and
a second comparator configured to compare the PWM signal with a first low input threshold voltage and output the second control signal according to a comparison result between the PWM signal and the first low input threshold voltage;
wherein a positive input terminal of the first comparator and a negative input terminal of the second comparator receive the PWM signal;
wherein the first high input threshold voltage is lower than a high logic level of the PWM signal and higher than a high-impedance logic level, and
wherein the first low input threshold voltage is lower than the high-impedance logic level and higher than a low logic level of the PWM signal.

6. The voltage converting circuit of claim 5, wherein when the PWM signal is higher than the first high input threshold voltage, the discharge switch is turned on to form a fast discharge path for the PWM signal.

7. The voltage converting circuit of claim 5, wherein the logic circuit further comprises:
a NOR gate coupled to the first and second comparators to receive the first and second control signals, and configured to output a third control signal according to the first and second control signals.

8. The voltage converting circuit of claim 7, wherein the logic circuit further comprises:
a first AND gate coupled to the discharge switch, and configured to perform an AND logic operation on the third control signal and one of the inversion of the second control signal and the inversion of the low-side control signal and further to output a switch control signal to the discharge switch to control an on/off state of the discharge switch.

9. The voltage converting circuit of claim 7, wherein an inversion of the third control signal is used for directly controlling an on/off state of the discharge switch.

10. The voltage converting circuit of claim 5, further comprising:
a level generating circuit coupled to the input node to receive the PWM signal, and configured to output a switch conducting signal according to the PWM signal, wherein the level generating circuit comprises:
a third comparator configured to compare the PWM signal with a second high input threshold voltage and correspondingly output a first comparing signal according to a comparison result between the PWM signal and the second high input threshold voltage;
a fourth comparator configured to compare the PWM signal with a second low input threshold voltage and correspondingly output a second comparing signal according to a comparison result between the PWM signal and the second low input threshold voltage; and
a SR flip-flop coupled to the third and fourth comparators to receive the first and second comparing signals, and configured to correspondingly output the switch conducting signal,
wherein a negative input terminal of the third comparator and a negative input terminal of the fourth comparator receive the PWM signal.

11. The voltage converting circuit of claim 10, wherein the second high input threshold voltage is lower than the high logic level of the PWM signal and higher than the first high input threshold voltage, and the second low input threshold voltage is lower than the first high input threshold voltage and higher than the high-impedance logic level.

12. The voltage converting circuit of claim 10, wherein the switch conducting signal is used for directly controlling an on/off state of the discharge switch.

13. The voltage converting circuit of claim 10, further comprising:
a first AND gate coupled to the discharge switch, and configured to perform an AND logic operation on the switch conducting signal and one of the inversion of the second control signal and the inversion of the low-side control signal and further to output a switch control signal to the discharge switch to control an on/off state of the discharge switch.

14. The voltage converting circuit of claim 1, further comprising:
a switch control circuit coupled to the discharge switch, and configured to output a switch control signal to the discharge switch to control an on/off state of the discharge switch, wherein the switch control circuit comprises:
an OR gate configured to receive the first control signal, an inversion of a third control signal, the inversion of the second control signal, the bootstrap power signal, the high-side control signal, the inversion of the low-side control signal, the phase output signal, and a switch conducting signal and further to perform an OR logic operation on the received signals so as to correspondingly output an enable signal; and
a second AND gate coupled to the OR gate to receive the enable signal, and configured to perform an AND logic operation on the enable signal, the inversion of the third control signal, and the switch conducting signal and further to output the switch control signal,
wherein the third control signal indicates whether the PWM signal is in a high-impedance logic mode, and the switch conducting signal is correlated with a level of the PWM signal.

15. A method for converting voltage, comprising:
by an input node, providing a PWM signal;
by a logic circuit, receiving the PWM signal and outputting a first control signal and a second control signal according to the PWM signal;
by a driver control circuit, receiving the first and second control signals and outputting a high-side control signal and a low-side control signal according to the first and second control signals, wherein a bootstrap power signal for driving the driver control circuit is further received by the driver control circuit;
by a control terminal of a high-side switch, receiving the high-side control signal;
by a control terminal of a low-side switch, receiving the low-side control signal;
outputting a phase output signal at a first terminal of the low-side switch and a second terminal of the high-side switch; and
controlling an on/off state of a discharge switch, wherein the discharge switch is coupled between the input node and a ground terminal;
wherein the discharge switch is controlled by at least one of the PWM signal, the first control signal, an inversion of the second control signal, the bootstrap power signal, the high-side control signal, an inversion of the low-side control signal, and the phase output signal.

16. The method for converting voltage of claim 15, wherein when the PWM signal is in a high logic mode or in a process of transitioning from the high logic mode to a high-impedance logic mode, the discharge switch is turned on to form a fast discharge path for the PWM signal.

17. The method for converting voltage of claim 15, further comprising:
by the logic circuit, receiving the PWM signal and outputting a third control signal according to the PWM signal, wherein the third control signal indicates whether the PWM signal is in a high-impedance logic mode;
wherein the discharge switch is further controlled by an inversion of the third control signal.

18. The method for converting voltage of claim 15, wherein when the PWM signal is in a high-impedance logic mode, the discharge switch is turned off.

19. The method for converting voltage of claim 15, wherein the discharge switch is directly controlled by one of the first control signal, the bootstrap power signal, the high-side control signal, and the phase output signal.

20. The method for converting voltage of claim 15, wherein the discharge switch is coupled in series with a resistor or a current sink between the input node and the ground terminal.
